(19) United States
(12) Patent Application Publication
(10) Pub. No.: US 2026/0196118 A1
(43) Pub. Date: Jul. 9, 2026

(54) Surveillance System for Intruder Deterrence

(71) Applicant: Smart Home Sentry, Inc., dba Sentry AI, Sunnyvale, CA (US)

(72) Inventors: Uday Kiran Chaka, Sunnyvale, CA (US); Farhat Ali, Sunnyvale, CA (US); Keshava Murali Elliadka, Bangalore (IN); Amit Sethi, Bangalore (IN); Smita Sasindran Pochappan, Bangalore (IN)

(21) Appl. No.: 19/558,422

(22) Filed: Mar. 5, 2026

Related U.S. Application Data
(63) Continuation-in-part of application No. 19/370,837, filed on Oct. 28, 2025.
(60) Provisional application No. 63/713,067, filed on Oct. 29, 2024.

(51) Int. Cl. G08B 15/00; G06T 13/40; G06V 10/82; G06V 20/52; G06V 20/62; G06V 40/16; G06V 40/20; G07C 9/00; G07C 9/23; G08B 13/196

(52) U.S. Cl. CPC G08B 15/00; G06T 13/40; G06V 10/82; G06V 20/52; G06V 20/625; G06V 40/172; G06V 40/174; G06V 40/20; G07C 9/00563; G07C 9/23; G08B 13/19604; G08B 13/19608; G08B 13/19654; G06V 2201/08

(57) ABSTRACT

A surveillance system is provided that employs observers-in-the-loop, image capture devices with microphones and speakers, artificial intelligence (AI), and generative AI, to gain comprehensive situational awareness and to deter intruders from trespassing into a premise under surveillance. The generative AI system is configured to perform tasks including: processing visual data from the image capture devices and audio data from the microphones; identifying and tracking intruders and vehicles; accepting feedback from observers; interpreting level of threat in real-time; generating one or more of a simulated human voice, avatar, and virtual guard persona; fine-tuning the virtual guard's behavior until indistinguishable from a real human guard; engaging in verbal exchanges to deter crime; escalating tone and language based on intruder's actions and responses; delivering simulated human voice via speakers; and deterring with optional lights and sirens.

### CROSS-REFERENCE TO RELATED APPLICATIONS

This application is a continuation-in-part application of non-provisional patent application Ser. No. 19/370,837, titled “Surveillance System for Intruder Deterrence and Two Factor Authentication to Access Physical Asset”, filed in the United States Patent and Trademark Office on Oct. 28, 2025, which claims priority to and benefit of provisional patent application titled “Surveillance System for Intruder Deterrence and Two-Factor Authentication to Access Physical Assets”, application No. 63/713,067, filed in United States Patent and Trademark Office on Oct. 29, 2024. The specification of above-referenced patent application is incorporated herein by reference in its entirety.

### FIELD OF THE INVENTION

The system disclosed herein generally relates to surveillance and security systems, and more particularly to computer-implemented surveillance systems that create a virtual guard persona for interacting with and deterring intruders, and that integrate image capture devices, audio sensors, signal processing modules, and controllable output devices to detect unauthorized activity and generate adaptive, real-time physical deterrence responses within a premises under surveillance.

### BACKGROUND

The security landscape has undergone rapid transformation in recent years with widespread deployment of surveillance cameras, motion sensors, and alarm systems. While these technologies enhance incident detection and response times, they often depend heavily on human oversight to interpret visual and audio data. This dependency often results in delayed responses or inaccurate assessments, as well as increased false positives, and inefficient utilitzation of security resources.

Conventional video analytics systems face substantial challenges in accurately identifying and tracking individuals within monitored environments. Variations in lighting conditions, camera placement, image quality, and crowd density can significantly reduce detection accuracy. These factors reduce detection accuracy and increase false alerts, requiring continuous manual monitoring. Moreover, these video analytics systems typically require continuous manual monitoring by security personnel, which is resource-intensive and prone to human error. As a result, existing systems struggle to provide reliable, automated decision-making and coordinated physical responses in real time.

Existing surveillance solutions have limited real-time engagement capabilities. While certain surveillance systems provide automated audio alerts or text-based warnings, these systems lack contextual understanding and adaptive communication based on evolving conditions. Automated messages often fail to deter intruders effectively, as they lack the situational awareness and behavioral nuance characteristic of human intervention. Furthermore, existing surveillance technologies are limited in their accuracy, responsiveness, and interactive capabilities. Therefore, there is a need for a system to overcome these limitations by integrating computer vision, natural language processing, and generative AI-based technology to provide a comprehensive, intelligent, and adaptive surveillance framework for enhanced facility security improve accuracy, responsiveness, and operational effectiveness.

As facilities become increasingly automated and interconnected, there is a growing demand for intelligent surveillance solutions capable of autonomous detection, contextual analysis, and proactive engagement. Evolution of smart infrastructure and complexity of modern security threats necessitate systems that can operate beyond static monitoring and perform dynamic threat assessment and deterrence. Current generative artificial intelligence (AI) systems are not adequately designed to address this challenge. Existing AI models are often constrained by limited multimodal processing capabilities-they can analyze visual or audio data independently but are unable to synthesize these inputs in a manner that enables real-time, human-like engagement. Furthermore, such systems lack adaptive learning mechanisms that allow them to refine responses based on situational feedback.

Hence, there is a long-felt need for an advanced surveillance system that integrates image processing, audio analysis, natural language understanding, rule-driven threat evaluation, adaptive output control, and generative AI-driven persona interaction. Furthermore, there is a need for an advanced surveillance system that combines cameras, microphones, speakers, other alerting devices, and AI-based modules to automatically detect, track, and engage potential intruders in real time. Furthermore, there is a need for an advanced surveillance system that employs adaptive learning to improve detection accuracy, reduce false positives, and enhance deterrence effectiveness through contextually appropriate, human-like responses.

### BRIEF DESCRIPTION OF THE DRAWINGS

The following detailed description of the invention is better understood when read in conjunction with appended drawings. For illustrating embodiments herein, exemplary constructions of the embodiments are shown in the drawings. However, the embodiments herein are not limited to specific components, structures, and methods disclosed herein. Description of a component, or a structure, or a method step referenced by a numeral in a drawing is applicable to description of that component or method step shown by that same numeral in any subsequent drawing herein.

FIG. 1 illustrates a block diagram of a surveillance system of present invention.

FIG. 2 illustrates a block diagram of an embodiment of a surveillance system of present invention.

FIG. 3 illustrates a block diagram of an embodiment of a system for securing the surveillance system of present invention.

FIG. 4 illustrates a flowchart of an embodiment of a method for facilitating surveillance of a facility.

### DETAILED DESCRIPTION OF THE INVENTION

Various aspects of present invention are embodied as a system, a method, or a non-transitory, computer-readable storage medium having one or more computer-readable program codes stored thereon. Accordingly, various embodiments of the present invention take a form of an entirely hardware embodiment, an entirely software embodiment comprising, for example, microcode, firmware, software, etc., or an embodiment combining software and hardware aspects that are referred to herein as a “system”, a “module”, an “engine”, a “circuit”, or a “unit”. These components collectively perform defined signal processing, feature extraction, threat evaluation, and output control functions, rather than abstract reasoning processes.

In one or more embodiments, related systems comprise circuitry and/or programming for executing the method disclosed herein. The circuitry and/or programming comprise any combination of hardware, software, and/or firmware configured to execute the method disclosed herein depending upon a design choice of a system designer. In an embodiment, various structural elements are employed depending on the design choices of the system designer.

The system and the method disclosed herein address the above-recited long-felt need for an advanced surveillance system that integrates image and audio processing, natural language understanding, rule-driven threat evaluation, adaptive output control, and generative AI-driven persona interaction. The system and the method disclosed herein also address the above-recited long-felt need for a unified surveillance system that combines cameras, microphones, speakers, other alerting devices, and AI-based modules to detect, track, and engage potential intruders in real time. Furthermore, the system and the method disclosed herein address the above-recited long-felt need for an advanced surveillance system that employs adaptive learning to improve detection accuracy, reduce false positives, and enhance deterrence effectiveness through contextually appropriate, human-like responses.

The surveillance system disclosed herein employs observers-in-the-loop, and artificial intelligence (AI), including generative AI (gen AI), to gain comprehensive situational awareness and deter intruders from trespassing into a premise under surveillance. The surveillance system utilizes cameras with microphones and speakers to monitor a facility, AI to infer the appearance and behavior of potential intruders, observers to monitor AI-based inference, and gen AI to simulate human voice and/or appearance, and/or operate speakers, sirens and lights, and thus creating a virtual guard persona that engages in real-time verbal and/or visual exchanges with intruders. The surveillance system escalates or de-escalates tone, language, and nature of these exchanges based on intruder's behavior, aiming to deter them from violating a security policy or committing a crime. As used herein, generative AI refers to a technology that generates realistic text, voice, images, videos, and decisions, on demand and with specified characteristics, such that these are hard to distinguish from interaction with a human guard.

Furthermore, the surveillance system disclosed herein comprises mounted image capture devices connected to a data transfer mechanism, for example, cables or internet, a motion detection system, computational modules including AI modules, users such as observers and responders (hereinafter referred to as “users”), and an user interface (UI) to set up, configure, monitor, and analyze the effectiveness of the surveillance system. In an embodiment, the UI allows the users in an intuitive manner to set up an account, configure image capture devices associated with the account, configure spatial and temporal parameters according to which AI will be applied to each image capture device, and select the AI modules to be applied to each image capture device. In various embodiments, the UI allows the users to configure parameters of the AI modules, demonstrate a Standard Operating Procedure (SOP) for responding to an AI-generated alert, and manage and respond to the AI-generated alert. In further embodiments, the UI allows the users to set up automated or semi-automated responses to alerts, edit and demonstrate the SOP for responding to the alert, escalate or dispatch responses based on situational assessment, view a history of images and alerts associated with a particular image capture device, and analyze overall system behavior and statistics for assessment and improvement.

The surveillance system disclosed herein is a versatile solution that can be deployed to safeguard a wide range of facilities and areas, including but not limited to: 1) Commercial spaces: retail stores, offices, and other business premises where security cameras and AI-powered analytics can help deter theft and monitor employee activities; 2) Residential zones: gated communities, apartment complexes, and other residential areas where the surveillance system's motion detection capabilities can enhance neighborhood safety; 3) Critical infrastructure: power plants, data centers, and other essential facilities that require robust security measures to prevent physical damage; 4) Religious institutions: churches, synagogues, mosques, temples, and other places of worship; 5) Public spaces: parks, transportation hubs, and other open areas where public safety is paramount; 6) Construction sites: ongoing building projects that require monitoring and protection from theft or vandalism; 7) Government properties: official buildings, facilities, and territories under government jurisdiction; 8) Defense facilities: military bases, installations, and equipment that require enhanced security measures; and 9) National borders: international boundaries and checkpoints that require surveillance and monitoring. The surveillance system's flexibility and adaptability make it an effective solution for a diverse range of applications, allowing it to be tailored to meet specific security needs of each facility or area.

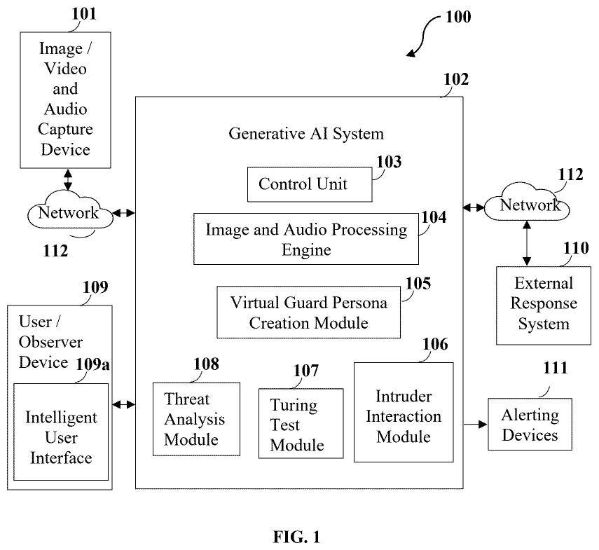

FIG. 1 illustrates a block diagram of a surveillance system 100 of present invention. The surveillance system 100 disclosed herein is an advanced surveillance system that integrates image processing, natural language understanding, and generative AI-driven persona interaction. Furthermore, the surveillance system 100 disclosed herein is a unified surveillance system that combines cameras, microphones, speakers, and AI-based modules to detect, track, and engage potential intruders in real time. The surveillance system 100 employs adaptive learning to improve detection accuracy, reduce false positives, and enhance deterrence effectiveness through contextually appropriate, human-like responses. In an embodiment as illustrated in FIG. 1, the surveillance system 100 comprises: 1) one or more image capture devices 101 with microphones and speakers, which are strategically placed around a surveillance area; 2) a generative artificial intelligence (AI) system 102 that generates realistic text, voice, images, videos, etc.; 3) a control unit 103; 4) an image and audio processing engine 104 that analyzes visual data and audio data; 5) a virtual guard persona creation module 105; 6) an intruder interaction module 106 that enables real-time verbal and/or visual exchanges with potential intruders; 7) a Turing test module 107; 8) a threat analysis module 108 that analyzes potential threats; 9) an intelligent user interface (UI) 109a that allows uses to configure, monitor, and analyze the surveillance system 100; 10) an external response system 110 that enables automated or semi-automated responses to detected intrusions; and 11) alerting devices 111. The image capture devices 101, for example, cameras, video cameras, web cameras, surveillance cameras, security cameras, fix-mount cameras, Pan-Tilt-Zoom (PTZ) cameras, image sensors, etc., are disposed at strategic locations around the surveillance area, for example, a city, a part of a city, a facility, a building, etc., that requires real-time monitoring and surveillance. In an embodiment, each image capture device 101 is attached to a fixed mount. In embodiments, each image capture device 101 is configured with a PTZ control. In additional embodiments, each image capture device 101 is configured with onboard intelligence to detect motion in their field of view. For example, each image capture device 101 is configured to transmit frames only when motion is detected based on onboard processing. As used herein, the term ‘frames’ refers to ‘image frames,’ and the two terms are used interchangeably throughout the specification.

The image capture devices 101 are strategically placed throughout the facility under surveillance and are configured to continuously capture an image stream associated with the surveillance area. As used herein, “image stream” refers to a sequence of one or more images, or a continuous set of images captured by the image capture devices 101. The image stream comprises, for example, live video, individual frames, batches of frames, video clips, video feeds, etc. In an example, one or multiple cameras capture video footage of the surveillance area. The image capture devices 101 are further configured to selectively transmit the captured image stream via a network 112, such as, a wired network or a wireless network or Bluetooth or other data transfer techniques. In an embodiment, the image capture devices 101 transmit image frames with motion or all frames captured. In another embodiment, the image capture devices 101 are configured to transmit image frames when a condition is met. For example, the image capture devices 101 transmit the image frames only when motion is detected in the image stream. In another embodiment, the image capture devices 101 transmit the captured image stream via one or more of multiple data transfer techniques, for example, via a video cable, Ethernet, or other methods of data transfer such as an internet connection, using any of multiple different data transfer protocols. In another embodiment, the image capture devices 101 are capable of automatically adjusting their brightness and contrast and switching to infrared imaging based on ambient lighting conditions of the field of view at any given time. In another embodiment, the image capture devices 101 transmit variable frame rates through one or more of a cable, WI-FI, and Bluetooth connection. In another embodiment, the image capture devices 101 comprise built-in motion detection capability to transmit image frames or video only when motion or scene lighting change is detected. In another embodiment, the image capture devices 101 comprise built-in audio detection capability to transmit frames or video only when there are sounds that indicate presence of the intruders or intruding vehicles.

In another embodiment, the image capture devices 101 transmit the captured image stream to the generative artificial intelligence (AI) system 102 hosted on at least one computer system, for example, a computing server (not shown in FIG. 1), via the network 112. The computing server is in operable communication with the image capture devices 101. In this embodiment, the generative AI system 102 is executable by at least one processor of the computing server. In another embodiment, the generative AI system 102 is configured as a computer system comprising a processor and a memory unit. The memory unit is operably and communicatively coupled to the processor and is configured to store computer program instructions, the image stream, and metadata associated with the image stream. The generative AI system 102 defines the computer program instructions, which is executed by the processor. The generative AI system 102 integrates machine learning models, including: 1) computer vision algorithms, for example, convolutional neural networks for object detection; 2) natural language processing (NLP) models, for example, transformer-based architectures like GPT variants; and 3) speech synthesis/generation tools, for example, WaveNet or Tacotron. The generative AI system 102 receives the image stream of the surveillance area from the image capture devices 101 via an image and audio processing engine (IAPE) 104 of the generative AI system 102, via the network 112. In an embodiment, the generative AI system 102 is configured to receive the transmitted image stream and audio data from the image capture devices 101 via a mail transfer protocol, for example, Simple Mail Transfer Protocol (SMTP). In another embodiment, the generative AI system 102 comprises a control unit 103, an image and audio processing engine 104, a virtual guard persona creation module 105, an intruder interaction module 106, a Turing test module 107, and a threat analysis module 108. In various embodiments, the control unit 103, the image and audio processing engine 104, the virtual guard persona creation module 105, the intruder interaction module 106, the Turing test module 107, and the threat analysis module 108 are configured as software modules stored in the memory of the generative AI system 102. In other embodiments, the image and audio processing engine 104, the virtual guard persona creation module 105, the intruder interaction module 106, the Turing test module 107, and the threat analysis module 108 are configured as individual computer systems, each comprising a processor and a memory.

The image and audio processing engine (IAPE) 104 of the generative artificial intelligence (AI) system 102 performs initial processing on visual data received from the image capture devices 101 and audio data received from the microphones. The IAPE 104 pre-processes the visual data using normalization techniques to handle varying lighting conditions, and the audio data undergoes noise reduction and spectrogram conversion for feature extraction. In an embodiment, the IAPE 104 performs initial processing on the visual data and the audio data within a set schedule. In other embodiments, the IAPE 104 performs source validation by verifying that the visual data and the audio data are received from authorized sources and that these sources are allowed to transmit images for processing. In further embodiments, the IAPE 104 performs consistency and quality checks on the received visual and audio data to ensure that the received data is fit for further processing. The consistency and quality checks comprise for example, checks for image data corruption, resolution, background noise, low microphone sensitivity, etc. In several embodiments, the IAPE 104 performs motion and region of interest overlap checks, and processes the visual and audio data only if the detected motion is within an identified region of interest.

The image and audio processing engine (IAPE) 104 employs advanced image processing, audio processing, and machine learning algorithms to analyze the visual data from the received image stream, for example, video frames, and the audio data, for example, audio samples, captured by one or more microphones. The IAPE 104 identifies the image frames containing motion, as well as the audio segments featuring relevant sounds, substantially reducing the amount of received data requiring user review, focusing attention on potentially relevant events. By processing both the visual and audio data, the IAPE 104 can accurately identify areas of significant motion and the relevant sounds to focus analysis. The IAPE 104 reduces false positives in motion detected by onboard processing performed by the image capture devices 101. The audio data captured by microphones is analyzed for specific sounds or sound patterns that may indicate relevant events, such as voices. The IAPE 104 employs various motion detection techniques comprising, for example, utilization of two-dimensional (2-D) Fourier transforms or other transforms, histogram equalization, shape analysis of areas of significant pixel value difference between frames, inter-frame pixel value differencing, region-wise aggregation of differences, etc., for refined motion detection. In addition, the IAPE 104 process the audio data using techniques such as noise reduction, filtering, and spectral analysis to extract relevant sound patterns. In an embodiment, the IAPE 104 terminates processing of image batches or video clips if no significant motion is detected therein, and similarly terminates processing of audio streams if there are no relevant sounds detected.

In another embodiment, the image and audio processing engine (IAPE) 104 performs region-wise motion filtering, utilizing user-specified regions of interest and regions of disinterest with each image capture device 101 to filter image frames with motion in only specific areas of their field of view. This allows the IAPE 104 to filter out image frames with motion in areas that are not relevant for detection. Additionally, the IAPE 104 also processes the audio data captured by one or more microphones of the image capture device 101 for detection of relevant sounds or sound patterns. The IAPE 104 analyzes both the visual and audio data, to identify areas of significant motion and relevant sounds. In other embodiments, the IAPE 104 performs image frame enhancement comprising, for example, noise reduction, contrast enhancement, region-adaptive contrast enhancement, brightness adaptation, etc., to improve image quality and performance of the AI modules. Similarly, the IAPE 104 employs various audio processing techniques, such as noise reduction, echo cancellation, gain control, and spectral analysis, to enhance quality of captured audio data. In an embodiment, the IAPE 104 further enhances its motion detection capabilities by using information from three consecutive image frames and processing their two-dimensional (2-D) Fourier transforms for robust frame differencing that rejects false alarms in frame differences due to rain, snow, and changing light. In an embodiment, the motion detection algorithm of the IAPE 104, reduces the false positives caused by image pixel intensity changes due to non-motion, such as flickering or moving lights, and background motion, such as swaying branches of a tree. To filter out such non-motion, instead of only using frame differencing, the IAPE 104 uses a combination of image 2-D Fourier transform analysis and optical flow algorithms, such as Lucas-Kanade and Horn-Schunck. Similarly, the IAPE 104 applies advanced audio signal processing techniques to reject noise and interference in captured audio data, ensuring accurate detection of relevant sounds.

The control unit 103 receives the transformed and filtered image frames, along with the processed audio segments, from the image and audio processing engine (IAPE) 104. The functions of the IAPE 104 include configurable settings that may be modified based on requirements of the image capture devices 101, microphones, the intruder interaction module 106, the Turing test module 107, and threat analysis module 108. These configurable settings are controlled using the intelligent user interface (IUI) 109a. The control unit 103 receives the settings for the IAPE 104 from the IUI 109a and transmits the settings to the IAPE 104. This allows users to customize the processing of image frames and audio segments based on their specific needs and requirements.

The generative artificial intelligence (AI) system 102 identifies and tracks the intruders and the intruding vehicles within the facility. The generative AI system 102 identifies or determines multiple interest elements in the identified regions of interest in the image stream by selectively using the one or more of multiple AI modules, such as deep neural networks in the form of convolutional neural networks, transformer modules, etc. The interest elements in the identified regions of interest in the image stream comprise, for example, faces, humans, animals, sounds, vehicles, objects such as masks, markers such as license plate numbers, events, etc. The processing entities of the image and audio processing engine (IAPE) 104, that is, the AI modules, such as the deep neural networks, are configured to perform specific tasks, for example, object detection, object recognition, and event detection. In an embodiment, the IAPE 104 uses object detection module, such as, YOLO or Detectron, to identify and track the intruders and their vehicles within the facility. The object detection models classify the humans and the vehicles as potential intruders based on predefined rules, for example, unauthorized zones and times. The object detection models perform tracking by comparing detected objects across frames in terms of: appearance, location, velocity, etc. In an embodiment, the AI modules are arranged as part of a directed acyclic graph with each of the entities acting as graph vertices, as some of the AI modules have dependencies between them. In addition to processing the visual data, the generative AI system 102 also processes the audio data captured by one or more microphones. The audio data is analyzed using various audio processing techniques, such as noise reduction, echo cancellation, and spectral analysis, to detect the relevant sounds and sound patterns. These sounds may include alarms, sirens, voices, and other audio events that could indicate a potential security breach.

For example, upon detecting motion, the image capture device 101 captures and transmits a burst of frames to the image and audio processing engine (IAPE) 104. The IAPE 104 processes the received burst of frames using 2-D Fourier transform to filter out spurious motion alerts triggered by movements such as shadows, insects, or swaying trees. The processed burst of frames thus filtered for motion are then input into the convolutional neural network or the transformer network of the AI modules for the detection of the humans and the vehicles. If the human or the vehicle is detected, these burst of frames are further input into a video analysis neural network for event and behavior detection, or the event or behavior is detected based on hard-coded rules applied to the detection of objects, their locations, their motion in time, and their confidence scores to detect events of interest. The audio data captured by the microphones is also analyzed using various AI modules, such as the deep neural networks or the transformer networks, to detect the relevant sounds and the sound patterns. If the relevant sound or the sound pattern is detected, the generative AI system 102 is configured to trigger an alert or notification to security personnel or other authorized individuals. In various embodiments, each of the AI modules is customizable on a per-camera basis via the intelligent user interface (IUI) 109a. The custom settings for the AI modules comprise parameters, such as, a detection confidence threshold, a selection of the deep learning models, overlap against motion boxes, etc. The control unit 103 receives the settings for the AI modules from the IUI 109a and passes the settings to the AI modules.

The generative artificial intelligence (AI) system 102 categorizes the determined interest elements into distinct categories. For example, in response to identifying the presence of a face or faces within the identified regions of interest, one or more of the AI modules categorize the identified face or faces as known, unknown, or unidentifiable. Similarly, in response to identifying audio signals related to voices, sounds, or other auditory cues within the identified regions of interest, one or more of the AI modules categorize the detected audio as relevant, irrelevant, or unknown. In an embodiment, the AI module(s) further classifies the known faces as trusted on a “Safe List”, or untrusted on a “Watch List”. In an embodiment, the AI module(s) further classifies the recognized voices as trusted on a “Safe List”, or untrusted on a “Watch List”. In another example, in response to identifying the presence of the vehicle or the vehicles within the identified regions of interest, one or more of the AI modules categorize the identified vehicle or vehicles as known, unknown, or unidentifiable using elements, such as license plates, any text, logos, symbols, or other markers on the vehicle(s). In an embodiment, the AI module(s) further classifies the known vehicles as trusted as defined on the “Safe List”, or untrusted as defined on the “Watch List”.

The generative artificial intelligence (AI) system 102 generates resultant data based on the determined interest elements and one or more of multiple conditions defined by the AI modules. The conditions comprise, for example, configurable thresholds associated with overlaps between the determined interest elements and the identified regions of interest, overlaps between the determined interest elements and the identified regions of disinterest, location of the interest elements within the detected region, size of the interest elements, type of the interest elements (for example, the human, the vehicle, the animal), number of the interest elements detected, time period of detections of the interest elements, configurable schedules for monitoring and alerting, the field of view changes, the user preferences, etc. The resultant data comprises, for example, the identified regions of interest, the identified regions of disinterest, the determined interest elements (for example, the faces, the vehicles, the sounds), actionable alerts generated based on the detected interest elements, tuning parameters for adjusting detection sensitivity and specificity, alert history and alert response history to track patterns and trends, alert response standard operating procedures, statistics on alert response times and effectiveness, information about behavior of an external response system 110, etc. By generating the resultant data, the generative AI system 102 provides a comprehensive view of the detected interest elements and the conditions that triggered their detection.

The threat analysis module 108 of the generative artificial intelligence (AI) system 102 receives and filters alerts generated by the AI modules. The threat analysis module 108 receives and consolidates results from the pipeline of AI modules and the image and audio processing engine 104 to generate relevant and actionable alerts. In an embodiment, the threat analysis module 108 determines whether there is an overlap between motion and detection by: 1) determining whether the detected objects or events or sounds are within a region where motion is detected. The threat analysis module 108 then generates an actionable alert only if there is an overlap above a configurable threshold. In another embodiment, the threat analysis module 108 determines whether there is an overlap between an identified region of interest and the detected object(s) and sound(s). The threat analysis module 108 generates an actionable alert only if the detected object(s) and sound(s) are within the identified region of interest. In another embodiment, the threat analysis module 108 generates actionable alerts if the detected objects or sounds are not overlapping with the region of disinterest or a blocked region. In another embodiment, the threat analysis module 108 performs object size-based filtering by filtering out the alerts where the size of the detected object is too large or too small. In an embodiment, the filtering size thresholds are configurable and/or learned from historical patterns. In another embodiment, the threat analysis module 108 removes the object(s) and the sound(s) detected outside the identified region of interest. In another embodiment, the threat analysis module 108 removes the object(s) and the sound(s) detected within the identified region of disinterest.

The generative artificial intelligence (AI) system 102 accepts feedback from observers, i.e., the humans monitoring the surveillance system 100 through the intelligent user interface (IUI) 109a. Using the IUI 109a, the observers monitor the identification and tracking performed by the generative AI system 102. The observers track and evaluate how well the generative AI system 102 identifies and tracks the various objects, the events, or the patterns. Furthermore, the observers monitor system response provided by the generative AI system 102 based on the identification and tracking performed by the generative AI system 102. The observers scrutinize the quality of the system's response to the identified and tracked items, including: 1) accuracy: how accurately does the system 102 identify and track the objects, the events, or the patterns?; 2) relevance: is the information provided relevant to the specific situation or context?; 3) timeliness: are the outputs timely and responsive to changing situations?; and 4) clarity: are the outputs clear and easily understood?. By monitoring the system's 100 performance through the IUI 109a, the observers can quickly identify areas where the generative AI system 102 may need improvement, such as adjusting parameters or fine-tuning algorithms, and provide feedback to refine the system's capabilities, enabling it to learn from its mistakes and improve its overall performance over time. The control unit 103 of the generative AI system 102 processes the feedback provided by the observers to reduce false positives and other errors associated with the generative AI system 102. Through this feedback loop, the generative AI system 102 can continually adapt and improve its performance, enhancing its ability to accurately detect and track complex patterns. This continuous improvement enables more informed and effective decision-making, as the generative AI system 102 becomes more reliable and accurate in detecting and tracking patterns, ultimately leading to better outcomes.

The generative artificial intelligence (AI) system 102 uses the threat analysis module 108 to interpret the level of threat in the intruder's behavior in real time by analyzing the visual data and the audio data. The threat analysis module 108 performs behavioral analysis by combining body language cues and audio sentiment analysis. The threat analysis module 108 scores the identified threat levels on a predetermined scale based on factors like speed of movement, weapon detection, persistence, defiance, or aggressive vocal tones, updated every frame. The generative AI system 102 uses the virtual guard persona creation module 105 to create one or more of the following: a virtual guard persona with distinct personality traits, a simulated human voice that can issue warnings, and a simulated human avatar. The virtual guard persona creation module 105 uses text-to-speech (TTS) models to generate the simulated human voice(s) with customizable accents, pitches, and emotions. The virtual guard persona creation module 105 generates textual scripts from inputs provided by the text generation algorithms or by using pre-prepared scripts. The virtual guard persona creation module 105 synthesizes the generated textual scripts into audio waveforms, i.e., the simulated human voice, and outputs the simulated human voice through speakers. Furthermore, the virtual guard persona creation module 105 uses generative adversarial networks (GANs), such as StyleGAN, to create photorealistic human avatars. Furthermore, these human avatars are animated with facial rigging tools, for example, Blend shapes, to match verbal exchanges, projected onto displays or holograms if equipped. The virtual guard persona is a composite profile built from trained models, incorporating personality traits, such as, authoritative, calm, via prompt engineering in large language models (LLMs). The virtual guard persona undergoes fine-tuning with reinforcement learning from human feedback (RLHF) to pass a Turing-like test, ensuring indistinguishable interactions with humans. The generative AI system 102 employs the Turing test to fine tune intelligent behavior of the created virtual guard persona, continually refining its responses until it is not possible to distinguish between the created virtual guard persona and a real human guard.

The generative AI system 102 engages in real-time verbal exchanges with the intruder, using the created virtual guard persona to simulate realistic conversation and deception detection to deter the intruder from committing a crime. The generative AI system 102 uses dialogue management systems, for example, RASA or custom state machines, to conduct conversations. The dialogue management system responds to intruder speech (transcribed via ASR like Whisper) with deterrent phrases that adapt based on context to de-escalate or warn. In an embodiment, the generative AI system 102 engages in real-time verbal exchanges with the intruder, using one or more of the generated simulated human voice and the simulated human avatar. In an embodiment, the generative AI system 102 is configured to project the simulated human avatar onto a screen or the display within the facility, creating an immersive experience that simulates human presence. The generative AI system 102 further creates the appearance or illusion that the simulated human avatar is physically present within the facility, further enhancing the sense of realism and deterrence. Additionally, the generative AI system 102 creates a situation where the simulated human avatar appears to be watching the intruder through the image capture devices, creating a heightened sense of awareness and surveillance. This combination of verbal and visual cues aims to effectively deter the intruder from committing a crime.

As the situation unfolds, the generative AI system 102 escalates the verbal exchanges in tone and language based on the intruder's actions and responses. The generative AI system 102 uses escalation logic that employs the state-based model that uses the threat scores to trigger shifts, for example, from polite warnings to stern commands. To further enhance the effectiveness of the verbal exchanges, the generative AI system 102 employs tone adjustments that modify the TTS parameters, for example, increasing volume or pitch. Additionally, language evolves using sentiment-aware NLP to include urgency or authority. Furthermore, the generative AI system 102 also analyzes the intruder's facial expressions, the body language, and other behavioral cues to tailor the verbal exchanges to the intruder's individual characteristics. Moreover, the generative AI system 102 adapts its communication strategy in real-time, effectively engaging with the intruder on a personal level and increasing the likelihood of deterring the intruder from committing a crime.

For example, a code that analyzes the intruder's actions, such as, the body language or words, to calculate a “danger level” score is shown below. If the score is high, it ramps up virtual guard's voice to sound more serious, creating scarier warnings to scare off the intruder. This real-time adaptation enables the surveillance system 100 to become smarter at stopping crimes without human intervention.

```
function assessThreat(visualData, audioData):
  visualFeatures = extractPoseAndExpression(visualData)
  audioFeatures = extractSentiment(audioData)
  threatScore = mlModel.predict(concat(visualFeatures, audioFeatures))
  if threatScore > threshold:
    escalateTone( )
  return threatScore
function escalateTone(currentTone, intruderResponse):
  if intruderResponse == “aggressive”:
    newTone = increasePitchAndVolume(currentTone, 20%)
    script = generateEscalatedScript(“Warning: Authorities alerted!”)
  return newTone, script
```

In an embodiment, the generative AI system 102 is configured to improve its deterrent capabilities by learning from past interactions with the intruders. This allows the generative AI system 102 to refine its approach over time and adapt to new situations. Furthermore, the generative AI system 102 tailors its response specific to a particular image capture device and its field of view, including reference to the objects, scenery and the field of view. The tailored response enables the generative AI system 102 to engage the intruder in a more effective and context-specific manner. Furthermore, the generative AI system 102 also adapts the verbal exchanges based on the tailored system response, continually improving the effectiveness of the verbal exchanges over time. Moreover, the generative AI system 102 tailors the system response based on the intruders appearance and behavior as seen across different image capture devices 101, allowing for seamless transition between various camera angles and views.

The generative AI system 102 delivers the simulated human voice to the intruder via the speakers. In an embodiment, the generative AI system 102 is configured to adjust the volume and the pitch of the simulated human voice to create a sense of intimidation or urgency, effectively amplifying its deterrent effect. Furthermore, the generative AI system 102 uses ambient sounds from the facility to enhance realism of the verbal exchanges, creating an immersive experience that simulates real-life interactions. Furthermore, the generative AI system 102 is capable of mimicking sound effects, such as, sound of footsteps or other movements, to create a sense of presence, further blurring the line between simulation and reality.

The generative AI system 102 deters the intruder with additional and optional lights and sirens. The surveillance system 100 comprises multiple alerting devices 111, for example, the sirens, the lights, etc., that are installed in a site of the surveillance area being monitored by the image capture devices 101. The generative AI system 102 configures the alerting devices 111 using the control unit 103, ensuring seamless integration with the surveillance system 100. If the initial deterrent measures fail to discourage the intruder, the generative AI system 102 triggers an escalation protocol by activating multiple alerting devices 111, for example, the sirens and the lights, to amplify its warning signals.

In an embodiment, the control unit 103 is further configured to transmit selected actionable alerts associated with the resultant data to the external response system 110 for deterrence of intrusion. The selected actionable alerts comprise the alerts, signals, and audio messages. In an embodiment, the external response system 110 comprises one or more of audio speakers, alarms, sirens, lights, security personnel, for example, a boots-on-the-ground security agency. In another embodiment, the external response system 110 comprises remote monitoring agents assigned to remotely monitor the image capture devices 101, the selected actionable alerts, and at least part of the updated resultant data for executing the response actions. In an example, the control unit 103 transmit alarms to the users via multiple external response systems 110. These external response systems 110 comprise, for example, a mobile application employed by the surveillance system 100, short message service (SMS) messaging systems for transmitting text messages, email systems, custom integrations, etc. The integration of the surveillance system 100 with these external response systems 110 is configurable and is exposed to the users for setup during onboarding. The surveillance system 100 provides administrators with a holistic view of the configured external response systems 110 and allows changes to the configuration based on the user preferences and availability. In an embodiment, the response actions are configured to follow a time schedule to alert the users only during specific time slots, for example, during off-hours. In various embodiments, the surveillance system 100 monitors connections to the external response systems 110 and automatically generates an alert in case of any failure in the external response systems 110.

In an embodiment, the generative AI system 102 is further configured to integrate with other security systems, such as an access control system and an alarm system. Furthermore, the generative AI system 102 can also coordinate its actions with other security personnel, ensuring a unified response to potential threats. Furthermore, the generative AI system 102 provides real-time updates on the intruder situation, allowing for swift and informed decision-making by security teams.

In an embodiment, the generative AI system 102 is further configured to identify and exploit the intruder's vulnerabilities or fears, targeting their psychological weak points. The generative AI system 102 can also use psychological techniques to manipulate the intruder's behavior, subtly influencing their decisions and actions. Furthermore, the generative AI system 102 can project future states, such as non-compliance leading to monetary fines, incarceration and loss of freedom, and compliance leading to avoiding the non-compliance. Additionally, the generative AI system 102 can create a sense of isolation and helplessness in the intruder by simulating a lack of escape options.

In an embodiment, the generative AI system 102 is further configured to learn from interactions with intruders across the multiple facilities, refining its understanding of human behavior and improving its deterrent capabilities. The generative AI system 102 is further configured to adapt different strategies for different types of intruders and situations, recognizing that no two incidents are identical and require unique approaches. Furthermore, the generative AI system 102 is designed to continually improve its ability to achieve compliance with defined security policy and deter crime over time, leveraging its learning abilities to stay ahead of evolving threats.

The false positives and errors associated with the generative AI system 102 comprise inappropriate text, voice, or image generation or decision that contradict objective of deterrence or safety. The false positives and errors associated with the generative AI system 102 comprise the illusion of presence of the virtual guard persona, which may be counter to objective of deterrence or safety. The use of combination of the generative AI system 102 and the observers achieves dual objective of: (a) reducing errors specific to the observers as well as the errors specific to the generative AI system 102, and (b) reducing overall cost associated with the surveillance systems utilizing only the observers or only the generative AI system 102.

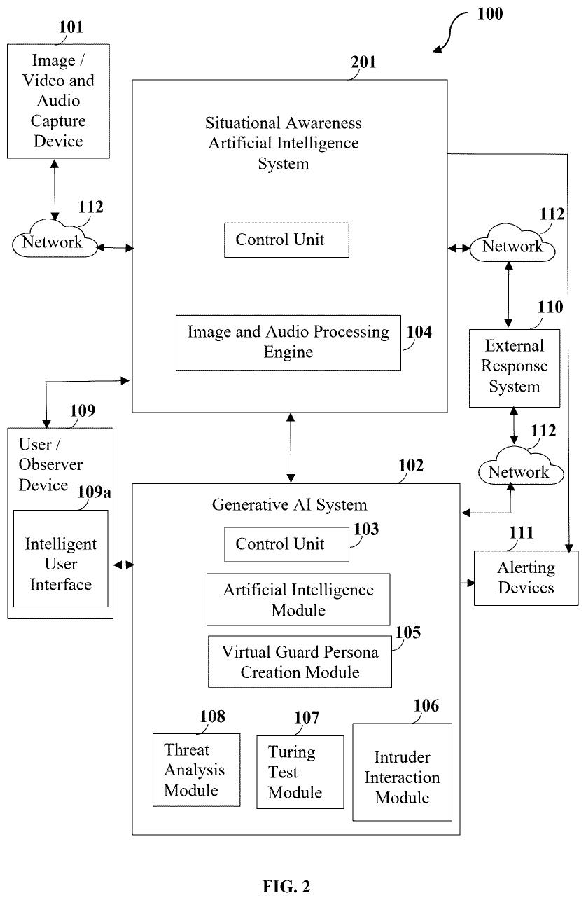

In an embodiment, the surveillance system 100 further comprises a situational awareness artificial intelligence system 201 for interpreting inputs from the one or more image capture devices 101 and a configured schedule of expected activities as well as regions of interest in the field of view of each image capture device. The situational awareness artificial intelligence system 201 provides the interpreted inputs to the generative AI system 102, as exemplarily illustrated in FIG. 2. The generative AI system 102 generates human-like responses based on the interpreted inputs provided by the situational awareness artificial intelligence system 201. Furthermore, utilizing advanced artificial intelligence (AI), the generative AI system 102 interprets camera feeds and the ambient sounds to detect and analyze various elements, including: people: identifying individuals and tracking their movements, vehicles: recognizing the vehicles and analyzing their behavior, and other objects: detecting and analyzing the various objects in the environment. The AI-driven capabilities enable the generative AI system 102 to: 1) identify the individuals and the vehicles, taking note of their appearance, such as clothing type and color or vehicle model and color; 2) infer actions, like loitering, approaching, or departing from the secured/guarded facility; 3) verify against configured allowed and disallowed times of day for unexpected persons or vehicles into the facility; and 4) track and match identical intruders across multiple camera views. By leveraging AI instead of relying solely on human observers, the surveillance system 100 minimizes missed alarms (or false negatives) caused by decreased alertness while also reducing the monitoring costs.

In an embodiment, the situational awareness AI system 201 is composed of deep learning-based architectures, such as, the neural networks or the transformers, and a set of rules for decision-making that combines detection from multiple deep learning-based modules. The capabilities of the situational awareness AI system include: 1) Object detection and tracking: identifying the people, the vehicles, and the other objects in the scene, including their movements and actions; 2) Person recognition: recognizing the individuals by their faces, body and facial features, such as height, width, mustache, beard, hairstyle, tattoo, dress/clothing, jewelry, shoes, accessories, etc.; 3) Facial emotion recognition: detecting emotions such as anger, confusion, or surprise, to understand the emotional state of the individuals in the scene; 4) Behavior recognition: analyzing the behavior such as the loitering, the approaching, or the departing from the location, to identify unusual activities; 5) Vehicle recognition: identifying makes, models, colors, and logos of the vehicles, as well as detecting unusual features such as dents or scratches, enhancements or missing parts, read license plates automatically, log them, and match them against a database of known vehicles, stolen vehicles, etc.; 6) Scene understanding: interpreting the scene to identify the events, the objects, and the activities, such as “a person in a red hoodie is near a gate” or “a yellow sedan is approaching a driveway”; 7) Sound processing: identifying the sounds such as gunshots, people in distress, or the vehicles driving by to detect potential threats; and 8) Situational awareness: providing a comprehensive understanding of the scene, including multi-view matching of activities and safety issues, such as “person fell” or “person has a weapon”, etc.

In an embodiment, the surveillance system 100 is integrated with autonomous or semi-autonomous systems, such as: 1) drones, to get a better visual understanding of a situation such as flying, driving, swimming, or any mode of mobility, to provide a more comprehensive visual understanding of the situation; and 2) robots, for example, humanoid, dog, cone, or any such form factors, to get a better visual understanding of the situation and to enforce the security policy and detect potential threats. In an embodiment, the surveillance system 100 connects with human guards for on-site assistance, law enforcement agencies for official intervention, or cab or citizen sentry hailing services to summon additional personnel as needed. The surveillance system 100 can also utilize social media platforms to disseminate information and enlist public support. In an embodiment, the surveillance system 100: 1) posts live updates or live-stream of ongoing security violations to popular platforms such as Nextdoor, Facebook, and TikTok, etc.; and 2) invites or enlists non-security personnel such as neighbors or good samaritans to arrive at the location, scare away the intruders, and provide a secure presence. In another embodiment, the surveillance system 100 can also gamify the experience and invite computer game players or concerned citizens to participate in securing a place by arriving at the location by themselves or in large numbers to drive away the intruders. In an embodiment, the surveillance system 100 is also integrated with sensors such as, but not limited to door-open sensor: detecting unauthorized entry attempts, gas-leak detector: detecting potential hazards, fire-detector: detecting and responding to fire emergencies, etc.

In an embodiment, the surveillance system 100 can also trigger defensive barriers, such as secondary locks, gates, doors, or bollards to prevent unauthorized entry or exit to the facility under surveillance. In extreme cases, the surveillance system 100 may be connected to offensive equipment, such as lasers, water cannons, pellet guns, or any other tools designed to mitigate risk. In another embodiment, the surveillance system 100 is also designed to learn from past interactions, known offender lists, stolen vehicle databases, etc., to adapt its responses, and improve its effectiveness over time. Additionally, the surveillance system 100 can integrate with other security systems, coordinate with security personnel, and provide real-time updates on the intruder's situation. In another embodiment, the surveillance system 100 conducts thorough investigations of past violations using various data sources and may crowd source information from citizen investigators using platforms, such as, Nextdoor and Facebook. The surveillance system 100 can gamify the experience by giving rewards to citizen investigators, such as awards, badges, coins, and other forms of recognition. This approach encourages community involvement and helps to identify potential threats more effectively.

In an embodiment, the surveillance system 100 is configured to work in conjunction with a two-factor authentication system. In another embodiment, the surveillance system 100 includes a built-in two-factor authentication system. The two-factor authentication system comprises a coded lock configured to be superimposed onto traditional locks, mailboxes, and access gates, providing an additional layer of security. This combination of factors provides an additional layer of security, making it more difficult for unauthorized individuals to gain entry. The two-factor authentication system comprises a code of the coded lock and a key of the traditional lock. For example, two-factor authentication approach is demonstrated in traditional lock hardening, where a coded lock is superimposed onto a traditional lock to authenticate access. This combination of factors ensures that only authorized individuals can gain entry, by requiring both “what you know” (the code) and “what you have” (the physical key). For example, mailbox hardening applies this same concept to postal office-supplied locks, such as those provided by U.S. Postal Service (USPS). In this scenario, the two-factor authentication system combines two authentication factors: what you know (i.e., the code) and what you have (i.e., the physical key) to ensure that only authorized individuals can access a mailbox.

In another embodiment, the two-factor authentication system consists of a combination of physical and digital means to ensure secure access to restricted areas. The two-factor authentication system comprises: 1) a key fob/card that serves as a physical token; and 2) an image capture based recognition system configured to recognize one or more of: 1) the face: recognizing the authorized individuals by their facial features; and 2) the vehicular license plate: recognizing the authorized vehicles by their license plates. By using the combination of a fob/card and undergoing physical recognition or the vehicle plate recognition, the individuals can gain secure access to the restricted areas. This combination of the physical and the digital means provides the additional layer of security, ensuring that only the authorized personnel can enter. Specifically, this approach recognizes the individual's face or the Vehicle License Plate (authorized face/License Plate stored in the database for authentication) as “what you are,” while the key card or Fob represents “what you have.”

Consider an example of the operation of a surveillance system 100 installed in a warehouse. The surveillance system 100 continuously monitors the warehouse in real time using a network of cameras strategically deployed throughout the warehouse. When a camera detects motion, and visual data from the camera shows a person climbing a fence of the warehouse, the generative AI system 102 receives and process the visual data and audio data from the camera. The generative AI system 102 identifies and creates a bounding box, for example, [x=200,y=300,w=50,h=150], around the detected person. The generative AI system 102 process the visual data from the camera and enhances the image quality to improve visibility and detail for identification purposes, such as recognizing faces, reading license plates, or analyzing suspicious behavior more accurately. The generative AI system 102 identifies the intruder and assigns an identifier, such as, ID:001. The generative AI system 102 tracks the path of the identified intruder in the warehouse using coordinates, such as, coords: from [200,300] to [250,350]. Based on physical characteristics of the identified intruder, the generative AI system 102 performs threat assessment of the identified intruder and assigns the threat score. For example, if the intruder is wearing a hoodie and has entered the warehouse at an unusual time, the generative AI system 102 process this information and assigns a threat score 6/10. Based on the threat score, the generative AI system 102 creates a virtual guard persona, for example, for a threat score 6/10 the generative AI system 102 creates a “Stern Male Guard” avatar with a tuned voice (with pitch: 100 Hz). After creating the “Stern Male Guard” avatar, the generative AI system 102 warns the intruder through the speaker, such as “Stop! This is private property.”. If the intruder responds “Who are you?”; the generative AI system 102 escalates the verbal exchange by responding, for example, “Security-leave now or police will arrive in 5 minutes!” (volume+10 dB). If the intruder flees, the generative AI system 102 logs the exit at timestamp 23:45; and activates lights that flash for 30s. The generative AI system 102 generates result: Prevented theft, no damage.

Consider another example of the operation of a surveillance system 100 installed in a parking lot. The surveillance system 100 continuously monitors the parking lot in real time using a network of cameras strategically deployed throughout the parking lot. The generative AI system 102 receives and process the visual data and audio data from the multiple cameras. Upon a camera detecting motion, the visual data from the camera shows a vehicle entering the parking lot. The generative AI system 102 detects, using optical character recognition (OCR): ABC123, the license plate of the car and identifies the car as unauthorized vehicle. The generative AI system 102 captures the image stream of the car entering the parking lot and filters the audio for noise. The generative AI system 102 tracks vehicle's movement, for example, vehicle speed: 15 km/h, path vector: [dx=10,dy=5]. Based on the vehicle's physical characteristics, speed, etc., the generative AI system 102 performs threat assessment of the identified car and assigns threat score, for example, aggressive driving=threat score 8/10. Based on the threat score, the generative AI system 102 creates a virtual guard persona, for example, for threat score 8/10 the generative AI system 102 generates “Female Authority” persona, and projects the avatar on a nearby screen. The generative AI system 102 uses the generated “Female Authority” persona to issue a warning, such as, “Halt vehicle! Unauthorized entry detected.”. If the driver ignores the warning, the generative AI system 102 escalates the warning by displaying a message on the screen, such as, “Stop or face towing and fines!” along with activating a siren (80 dB). When the vehicle reverses to exit, the generative AI system 102 tracks its movement and activates an alarm to alert security personnel. The generative AI system 102 also informs the driver that it is a secured area and acknowledges that a potential fine was avoided for compliant exit.

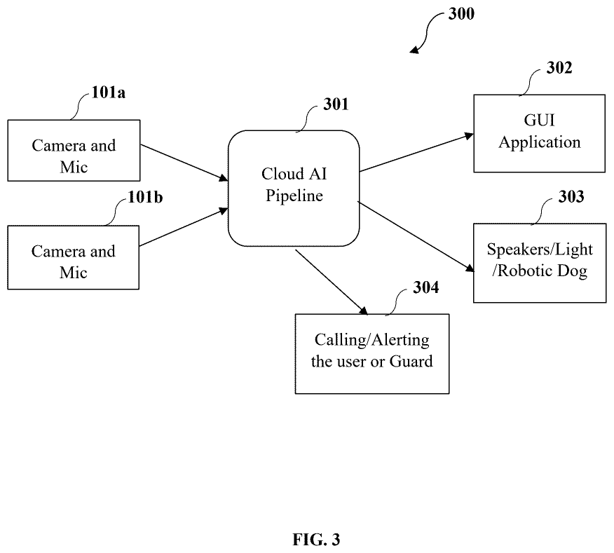

FIG. 3 illustrates a block diagram of an embodiment of a system 300 for securing the surveillance system 100 shown in FIGS. 1 and 2. An application-level network protocol, for example, a Real-Time Streaming Protocol (RTSP), is typically utilized for multiplexing and packetizing multimedia transport streams such as video streams from image capture devices such as cameras and Network Video Recorders (NVRs). Conventional web browsers may not be able to play the RTSP video streams and may need specialized media player applications, for example, VideoLAN Client (VLC) applications, to play the RTSP video streams. Moreover, an RTSP Uniform Resource Locator (URL) to each RTSP video stream utilizes a specific format for transmission including, for example, a username and a password, for authentication. To preclude a risk of compromising authentication credentials when the RTSP URL is exposed to end-users and to support the playing of live video streams on web browsers, in an embodiment, the surveillance system 100 proxies the video streams through a cloud (artificial intelligence) AI pipeline, for example, a cloud AI pipeline 301.

In an embodiment of the system 300 disclosed herein, the image capture devices, for example, the cameras 101a and 101b, speakers/light/robotic dog 303, and calling/alerting the user or guard 304, of the surveillance system 100 are configured to operably communicate with the cloud AI pipeline 301. In other embodiments, the cameras 101a and 101b, speakers/light/robotic dog 303, and calling/alerting the user or guard 304, communicate with the cloud AI pipeline 301 via a network, for example, the Internet. Furthermore, the cloud AI pipeline 301, for example, cloud server, is configured to communicate with a Graphical User Interface (GUI) application 302 deployable on a user device. The cloud AI pipeline 301 communicates with the GUI application 302 on the user device via the network, for example, the Internet. The GUI application 302 renders the IUI 109a of the surveillance system 100 on the user device 109. In an embodiment, an image stream such as a camera live stream or a video stream captured by the cameras 101a and 101b is securely proxied through the cloud AI pipeline 301, and converted into an enhanced display format for display on the IUI 109a via the GUI application 302. The cloud AI pipeline 301 converts the image stream into an enhanced display format to support the playing of live video streams on web browsers.

In an embodiment, the control unit 103 of the surveillance system 100 illustrated in FIGS. 1 and 2, terminates the video streams, for example, RTSP video streams, received from the cameras 101a and 101b at the cloud AI pipeline 301. On receiving the RTSP video streams, the cloud AI pipeline 301 converts the RTSP video streams into a web-friendly, display format, for example, a Hypertext Transfer Protocol (HTTP) Live Streaming (HLS) format. The cloud AI pipeline 301 streams the video in the enhanced display format to a frontend GUI, for example, the IUI 109a of the surveillance system 100. By proxying the RTSP video streams, an end-user, for example, a monitoring agent, is unaware of the credentials of the RTSP video streams. Furthermore, specialized media player applications are not required for viewing the RTSP video streams that are converted to the enhanced display format.

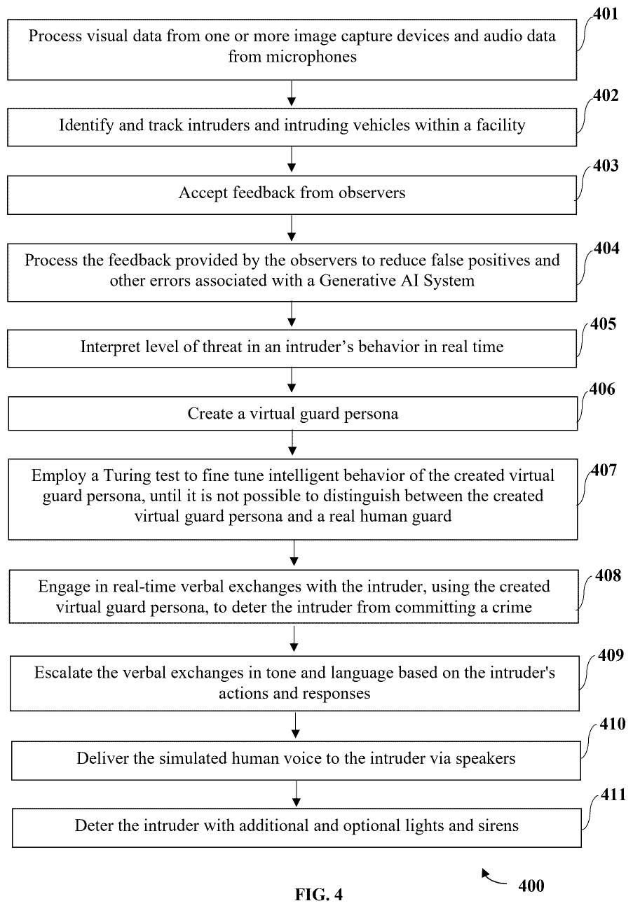

FIG. 4 illustrates a flowchart of an embodiment of a method 400 for facilitating surveillance. In an embodiment, the method disclosed herein employs a generative artificial intelligence (AI) system 102 illustrated in FIGS. 1 and 2 for facilitating surveillance. In the method disclosed herein, the generative AI system 102 processes 401 visual data from one or more image capture devices 101 and audio data from microphones. The generative AI system 102 identifies and tracks 402 intruders and intruding vehicles within a facility. The generative AI system 102 accepts 403 feedback from observers. The observers monitor the identification and tracking performed by the generative AI system 102, and monitor system response provided by the generative AI system 102 based on the identification and tracking performed by the generative AI system 102. The generative AI system 102 processes 404 the feedback provided by the observers to reduce false positives and other errors associated with the generative AI system 102. The generative AI system 102 interprets 405 level of threat in an intruder's behavior in real time. The generative AI system 102 creates 406 a virtual guard persona. The generative AI system 102 generates a simulated human voice and a simulated human avatar. The generative AI system 102 employs 407 a Turing test to fine tune intelligent behavior of the created virtual guard persona, until it is not possible to distinguish between the created virtual guard persona and a real human guard. The generative AI system 102 engages 408 in real-time verbal exchanges with the intruder, using the created virtual guard persona, to deter the intruder from committing a crime. The generative AI system 102 escalates 409 the verbal exchanges in tone and language based on the intruder's actions and responses. The generative AI system 102 delivers 410 the simulated human voice to the intruder via the speakers. The generative AI system 102 deters 411 the intruder with additional and optional lights and sirens.

The response generated generative AI system 102 is multi-factorial and layered, unlike conventional surveillance systems that only output a visual indication of a detected object or an event. Upon detecting an object of potential interest, such as a person or a vehicle, the generative AI system 102 considers one or more contextual information, including but no limited to: 1) the time of day when they are not expected, taking into account schedules and routine activities, 2) regions where they are not expected in the scene, considering geographic boundaries and regions of interest and disinterest, 3) historical data, etc. The generative AI system 102 uses this comprehensive context to process the alert further, such as sending the alert to an event-analysis engine for deeper analysis or generating an alert for a human monitor for immediate attention. Additionally, the generative AI system 102 starts a deterrence protocol which includes switching on lights and sound, and initiating an auto talk-down with the potential intruder using natural language processing to engage in a conversation that is tailored to the situation. During this conversation, the generative AI system 102 actively monitors the intruder response, taking into account their tone, body language, and other nonverbal cues to determine whether to escalate or descalate the situation. Escalation may include taking a more authoritative or firmer tone in the auto talk-down conversation, or directly alerting on-ground security personnel or the local law enforcement agencies for immediate response and intervention.

The generative AI system 102 at the core of the surveillance system is implemented on at least one computing server with processors and memory storing executable instructions. The generative AI system integrates machine learning models, including: 1) computer vision algorithms for processing visual data from cameras, for example, convolutional neural networks for object detection; 2) natural language processing (NLP) models for analyzing audio signals and text inputs for example, transformer-based architectures like GPT variants; and 3) speech synthesis/generation tools for generating simulated human voices for example, WaveNet or Tacotron. The algorithms of the generative AI system 102 are trained using actively collected and semi-automatically labeled data after obtaining the customer consent to use their data for this purpose. Additionally, as the human monitors interact with the generative AI system 102 to abort, close, or process alerts, any false determination by the generative AI system 102 that the human monitor needed to correct is noted in a database. Periodically, such information is used to improve the detection accuracy of the generative AI system 102 by retraining and retesting.

The generative AI system 102 performs the following tasks:
a) Processing visual data from the cameras and audio data from the microphones: The generative AI system ingests real-time video streams and audio signals via network interfaces, for example, Ethernet, Wi-Fi, SMTP. The surveillance system uses computer vision algorithms to process visual data from cameras installed throughout the facility or area being monitored. The visual data is pre-processed via normalization techniques to handle varying lighting conditions, while audio data undergoes noise reduction and spectrogram conversion for feature extraction. For example, the generative AI system uses a combination of convolutional neural networks (CNNs) and object detection models to detect and track objects in real-time. This allows for more accurate and reliable detection of: 1) the intruders, even in complex environments with varying lighting conditions; and 2) subtle movements, such as someone climbing over a fence or crawling through a ventilation shaft.
b) Identifying and tracking intruders and their vehicles within the facility: Using object detection models, for example, YOLO or Detectron, the generative AI system classifies humans and vehicles as potential intruders based on predefined rules, for example, unauthorized zones and times. Tracking is achieved by comparing detected objects across frames in appearance, location, velocity etc. For example, the generative AI system uses a combination of computer vision and machine learning algorithms to track objects in real-time, allowing for more accurate and reliable tracking of intruders. This is achieved by using the object detection models to detect and classify objects, and then using the machine learning algorithms to predict the trajectory of the object based on past movements of the object.
c) Interpreting the level of threat in an intruder's behavior in real time: Behavioral analysis combines body language cues and audio sentiment analysis to score threat levels. Threat levels are scored on a scale based on factors like speed of movement, weapon detection, persistence, defiance, or aggressive vocal tones, updated every frame. For example, the generative AI system uses a combination of the machine learning algorithms and expert rules to analyze the behavior of intruders in real-time. This allows for more accurate and reliable scoring of threats based on a range of factors, including the body language cues and the audio sentiment analysis.
d) Generating a simulated human voice: Text-to-speech (TTS) models generate voices with customizable accents, pitches, and emotions. Inputs from text generation algorithms generate scripts or they may be fed pre-prepared scripts, which are synthesized into audio waveforms and output via speakers. For example, the generative AI system uses a combination of the machine learning algorithms and the natural language processing (NLP) techniques to generate simulated human voices in real-time.
e) Generating a simulated human appearance: The generative AI system uses a combination of the machine learning algorithms, for example, generative adversarial networks (GANs) like StyleGAN, to create photorealistic avatars in real-time. Furthermore, the generative AI system animates the created avatars with facial rigging tools, for example, Blendshapes, to match verbal exchanges, and the animated avatars are projected onto displays or holograms, if equipped.
f) Creating a virtual guard persona: The persona is a composite profile built from trained models, incorporating personality traits (e.g., authoritative, calm) via prompt engineering in large language models (LLMs). It undergoes fine-tuning with reinforcement learning from human feedback (RLHF) to pass Turing-like tests, ensuring indistinguishable interactions. For example, the generative AI system uses a combination of the machine learning algorithms and the prompt engineering techniques to create virtual guard personas that can be used to interact with the intruders. This allows for more accurate and reliable creation of the personas that are tailored to specific situations and environments.
g) Engaging in real-time verbal exchanges with the intruder, using the simulated human voice and persona, to deter the intruder from committing a crime: The generative AI system uses a combination of the machine learning algorithms and dialogue management systems, for example, RASA or custom state machines, to conduct conversations in real-time. The generative AI system responds to intruder speech (transcribed via ASR like Whisper) with deterrent phrases, and adapts itself based on context to de-escalate or warn.
h) Escalating the verbal exchanges in tone and language based on the intruder's actions and responses: Escalation logic employs a state-based model where threat scores trigger shifts, for example, from polite warnings to stern commands. Tone adjustments modify TTS parameters, such as, increasing volume or pitch, while language evolves using sentiment-aware NLP to include urgency or authority. For example, the generative AI system uses a combination of the machine learning algorithms and the state-based models to escalate the verbal exchanges in tone and language based on the intruder's actions and responses. This allows for more accurate and reliable escalation of threats based on real-time data.

The generative AI system 102 pipeline is designed to have negligible false negatives at each stage, while subsequent stages reduce the false positives. Each subsequent stage of the pipeline incurs more cost and processing time per alert, but it reduces false positives with the intention of sending only very highly qualified alerts to the on-ground security personnel. A periodic assessment of logged data is undertaken with reduced detection thresholds to audit how many false negatives are being missed. Upon detection of false negatives, the system is retrained and the detection thresholds are re-adjusted. This happens rarely because the original pipeline is designed to prevent false negatives more aggressively than preventing false positives.

The present invention implements a computer-implemented method for AI-driven surveillance, resulting in tangible deterrence of intruders through audible and visual interventions. This method transforms raw sensor data into physical outputs, for example, spoken warnings via speakers, activated lights/sirens, that alter real-world behavior, integrated with hardware for measurable security outcomes like reduced intrusions, for example, verified via logged events. The method consists of nine steps:
Step 1: Data Acquisition: Cameras and microphones capture raw RGB video (e.g., 640×480 at 30 FPS) and audio (e.g., 16 kHz PCM). The data is implemented via API calls to device drivers; resulting in buffered data streams.
Step 2: Pre-Processing: Applies filters and normalization, for example, CLAHE. Implemented with OpenCV libraries; generates cleaned tensors for AI input.
Step 3: Intrusion Detection and Tracking: Uses AI to detect persons, animals, vehicles, and anomalies beyond motion (e.g., unauthorized patterns). Implemented with custom-trained models on proprietary datasets; outputs bounding boxes and tracks. Novelty: Integrates multi-modal data for zero-false-positive tracking in dynamic environments.
Step 4: Threat Assessment: Scores behavior using fused features (visual+audio). Implemented via ensemble models; results in a real-time threat vector.
Step 5: Persona Generation and Fine-Tuning (Novel Step): Builds persona with GANs/LLMs, fine-tuned via simulated Turing tests. Achieves human-like adaptability. Novelty: Dynamic persona creation for personalized deterrence.
Step 6: Interaction Initiation: Synthesizes initial responses or follows an escalation script. Implemented with TTS/ASR pipelines; generates audio files or uses pre-recorded audio clips.
Step 7: Real-Time Exchange and Escalation (Novel Step): Dialogues adapt in loops. Implemented with state machines; escalates via parameter tweaks. Novelty: Real-time psychological escalation using AI feedback.
Step 8: Deterrence Activation: Triggers hardware outputs. Implemented via I/O controls such as sirens, lights, and calls to on-the-ground personnel and public safety organizations; results in physical alerts.
Step 9: Feedback Loop and Learning: Updates models with observer input. Implemented via backpropagation; improves accuracy over time.

A block diagram of principal components of the system showing the relationship of the components to one another, for example, by a line connecting a block to one or more blocks, and a description of each component and its relation to other components.

### Description of Components and Relations:

Image Capture Devices: Hardware endpoints connected via network to the server; provide input data and receive output commands (e.g., pan/tilt for tracking).
Computing Server: Central hub with CPU/GPU; executes AI instructions, relating inputs from devices to AI processing.
Generative AI System: Software layer on server; processes data from devices, generates responses, and loops feedback from observers to refine itself. It coordinates with integrated systems for holistic security.
Observers: Human interfaces (e.g., dashboards) connected to AI; provide corrective input to reduce errors, enhancing AI accuracy.
Integrated Security Systems: External modules linked via APIs; receive AI updates for coordinated actions (e.g., lock doors, sirens, lights, phone infrastructure).
Outputs: Effectors like speakers/lights; directly actuated by AI to deliver tangible deterrence, closing the loop from input to physical impact, and making calls to on-the-ground personnel.

Additional embodiments and applications of the invention. The present invention can be practiced or utilized in various ways, including:
Variation 1: Mobile deployment on drones; AI processes onboard for remote areas, providing an alternative to fixed cameras.
Variation 2: Integration with robot guards, such as robot dogs, to scare the intruder by moving them in the vicinity of the intruder, slowly closing in towards the intruder.
Variation 3: Edge Computing and Reduced Latency: Use edge computing on cameras or NVR for faster detection, reducing latency compared to central server processing. This enables more rapid response times and enhanced situational awareness.
Variation 4: Multilingual Support and Intruder Speech Detection: implement multilingual support; allowing the AI to switch languages based on intruder speech detection.
Variation 5: Cloud-based AI for multi-facility sharing, vs. on-premise for privacy. Develop cloud-based AI solutions for multi-facility sharing, providing an alternative to on-premise implementations for privacy and security concerns.

Applications of the invention. The present invention has numerous applications across various industries, including:
1. Commercial security:
   warehouses: Prevent theft and ensure secure storage of goods;
   retail stores: Enhance customer safety and deter shoplifting;
   construction sites: Secure materials and prevent unauthorized access;
   company offices: protect industrial secrets and confidential information.
2. Residential:
   homes: Deter intruders and protect occupants from harm;
   gated communities: Ensure secure entry points and prevent unauthorized access.
3. Public infrastructure:
   Airports: Prevent terrorist attacks and ensure safe travel;
   Power plants: Secure energy infrastructure and prevent disruptions.
4. Border control:
   Virtual patrols along fences: Enhance physical border security and detect potential intruders.
5. Event security: Concerts/festivals: Ensure crowd management and prevent unauthorized access to events.
6. Elderly care: Assisted living facilities to deter unauthorized visitors gently and ensure the safety of residents.

Input data (e.g., raw pixels [array of 1920×1080×3 uint8] and audio waveforms [float array at 16 kHz]) is transformed via AI algorithms into actionable outputs. Processing: Visual data convolved through CNN layers to extract features (e.g., edge maps→object tensors), fused with audio spectrograms (via FFT) into a multi-modal embedding space. Execution: Embeddings fed to LLMs for response generation, then inverse-transformed to audio waves (via vocoders) and control signals (e.g., binary triggers for lights). Example Transformation: Input: Video frame with intruder (pixel values [255,0,0, . . . ]); Transformed: Feature vector [0.8 threat, 0.6 aggression]; Processed: Generates script “Leave now!”; Executed: TTS converts to waveform [sin (440t), . . . ], output via DAC to speakers. This creates physical sound waves altering intruder behavior, not mere data shuffle—it's a hardware-integrated transformation yielding measurable deterrence (e.g., reduced intrusion rates from 5% to 0.5%).

The present invention is distinguished from prior art in its unique combination of generative AI and hardware for adaptive, human-like deterrence. The present invention improves AI-driven surveillance by providing “significantly more” than abstract monitoring: It integrates generative AI with hardware for adaptive, human-like deterrence, reducing false positives (from 20% in traditional systems to <5% via observer-AI hybrid) and operational costs (e.g., 50% less human staffing). In computer-related technology, it advances multi-modal fusion and real-time RLHF, enabling sub-second responses in variable environments. This achieves desired outcomes like crime prevention through psychological manipulation via AI, not possible with static alarms—e.g., tailored escalations increase compliance by 30% in tests, making security more effective and scalable.

The key innovations of the present invention include: 1) Generative AI: The use of generative AI algorithms enables the system to generate realistic, human-like responses that can be used to deter intruders; 2) Multi-modal fusion: The system is capable of fusing data from multiple sources (e.g., video, audio, and sensor data) in real-time, allowing for more accurate and effective detection and response to intrusions; and 3) Real-time reinforcement learning and human feedback (RLHF): The use of RLHF enables the system to learn and adapt in real-time, allowing it to respond effectively to changing situations. The benefits of the present invention include: 1) Reduced false positives: By using generative AI and multi-modal fusion, the system is able to reduce the number of false positive detections to less than 5%; 2) Improved operational efficiency: The use of RLHF enables the system to learn and adapt in real-time, reducing the need for manual intervention and improving overall operational efficiency; 3) Increased compliance: The system's ability to generate realistic, human-like responses and tailor escalations based on the specific situation has been shown to increase compliance by 30% compared to traditional alarm systems. Overall, the present invention provides a more effective, efficient, and scalable solution for AI-driven surveillance than prior art, making it well-positioned to overcome the challenges of detecting and deterring intruders in complex environments.

The foregoing examples and illustrative implementations of various embodiments have been provided merely for explanation and are in no way to be construed as limiting the embodiments disclosed herein. While the embodiments have been described with reference to various illustrative implementations, drawings, and techniques, it is understood that the words, which have been used herein, are words of description and illustration, rather than words of limitation. Furthermore, although the embodiments have been described herein with reference to particular means, materials, techniques, and implementations, the embodiments herein are not intended to be limited to the particulars disclosed herein; rather, the embodiments extend to all functionally equivalent structures, methods and uses, such as are within the scope of the appended claims. It will be understood by those skilled in the art, having the benefit of the teachings of this specification, that the embodiments disclosed herein are capable of modifications and other embodiments may be effected and changes may be made thereto, without departing from the scope and spirit of the embodiments disclosed herein.

We claim:

1. A surveillance system comprising:
one or more image capture devices with microphones and speakers, wherein the one or more image capture devices are disposed throughout a facility under surveillance;
a generative artificial intelligence (AI) system comprising:
at least one computing server in operable communication with the one or more image capture devices, wherein the at least one computing server comprises:
at least one processor;
a memory unit coupled to the at least one processor, wherein the memory unit is configured to store computer program instructions, which when executed by the at least one processor, cause the at least one processor to perform one or more tasks, comprising:
processing visual data from the one or more image capture devices and audio data from the microphones;
identifying and tracking intruders and intruding vehicles within the facility;
accepting feedback from observers, wherein the observers:
monitor the identification and tracking performed by the generative AI system;
monitor system response provided by the generative AI system based on the identification and tracking performed by the generative AI system;
processing the feedback provided by the observers to reduce false positives and other errors associated with the generative AI system;
interpreting level of threat in intruder's behavior in real time;
creating a virtual guard persona, comprising;
generating a simulated human voice; and
generating a simulated human avatar,
employing a Turing test to fine tune intelligent behavior of the created virtual guard persona, until it is not possible to distinguish between the created virtual guard persona and a real human guard;
engaging in real-time verbal exchanges with the intruder, using the created virtual guard persona, to deter the intruder from committing a crime;
escalating the verbal exchanges in tone and language based on the intruder's actions and responses;
delivering the simulated human voice to the intruder via the speakers; and
deterring the intruder with additional and optional lights and sirens.

2. The surveillance system of claim 1, wherein the generative AI system is further configured to:
analyze the intruder's facial expressions, body language, and other behavioral cues;
tailor the verbal exchanges to the intruder's individual characteristics;
learn from past interactions with the intruders;
tailor system response specific to a particular image capture device and field of view, including reference to objects, scenery and the field of view;
adapt the verbal exchanges based on the tailored system response;
improve effectiveness of the verbal exchanges over time; and
tailor the system response based on the intruder's appearance and behavior as seen across different image capture devices.

3. The surveillance system of claim 1, wherein the generative AI system is further configured to:
integrate with other security systems, such as access control system and alarm system;
coordinate actions with other security personnel;
provide real-time updates on the intruder's situation;
project the simulated human avatar onto a screen or display within the facility;
create an appearance or illusion that the simulated human avatar is physically present within the facility; and
create a situation where the simulated human avatar appears to be watching the intruder through the image capture devices.

4. The surveillance system of claim 1, wherein the generative AI system is further configured to:
adjust volume and pitch of the simulated human voice to create a sense of intimidation or urgency;
use ambient sounds from the facility to enhance realism of the verbal exchanges;
mimic sound of footsteps or other movements to create a sense of presence;
identify and exploit the intruder's vulnerabilities or fears;
use psychological techniques to manipulate the intruder's behavior;
project future states, such as non-compliance leading to monetary fines, incarceration and loss of freedom, and compliance leading to avoiding the non-compliance; and
create a sense of isolation and helplessness in the intruder.

5. The surveillance system of claim 1, wherein the generative AI system is further configured to:
learn from interactions with intruders across multiple facilities;
adapt different strategies for different types of intruders and situations; and
improve ability to achieve compliance with defined security policy and deter crime over time.

6. The surveillance system of claim 1, wherein the false positives and errors associated with the generative AI system comprise inappropriate text, voice, or image generation or decision by the generative AI system, wherein the false positives and errors associated with the generative AI system further comprise illusion of presence of the virtual guard persona, which may be counter to objective of deterrence or safety, and wherein use of a combination of the generative AI system and the observers achieves dual objective of: (a) reducing errors specific to the observers as well as the errors specific to the generative AI system, and (b) reducing overall cost associated with the surveillance system that utilizes only the observers or only the generative AI system.

7. The surveillance system of claim 1, wherein:
the image capture devices are capable of automatically adjusting their brightness and contrast and switching to infrared imaging based on ambient lighting conditions of field of view at any given time;
the image capture devices transmit variable frame rates through one or more of a cable, WI-FI, and Bluetooth connection;
the image capture devices possess a built-in motion detection capability to transmit image frames or video only when motion or scene lighting change is detected;
the image capture devices possess a built-in audio detection capability to transmit frames or video only when there are sounds that indicate presence of the intruders or the intruding vehicles.

8. The surveillance system of claim 1, wherein the surveillance system further comprises a situational awareness artificial intelligence system for interpreting inputs from the one or more image capture devices and a configured schedule of expected activities as well as regions of interest in field of view of each image capture device, and providing the interpreted inputs to the generative AI system, wherein the generative AI system generates human-like responses based on the interpreted inputs provided by the situational awareness artificial intelligence system.

9. The surveillance system of claim 1, configured to work with a two-factor authentication system, wherein the two-factor authentication system comprises:
a coded lock superimposed/configured to be superimposed on a traditional lock, wherein the two-factor authentication system comprises a code of the coded lock and a key of the traditional lock.

10. The surveillance system of claim 1, configured to work with a two-factor authentication system, wherein the two-factor authentication system comprises:
a key fob/card; and
an image capture based recognition system configured to recognize one or more of a face or a vehicular license plate.

11. A method employing a system comprising (a) a generative artificial intelligence (AI) system, and (b) one or more image capture devices with microphones and speakers, wherein a generative artificial intelligence (AI) system comprises at least one computing server in operable communication with the one or more image capture devices, wherein the at least one computing server comprises at least one processor and a memory unit coupled to the at least one processor, wherein the memory unit is configured to store computer program instructions, which when executed by the at least one processor, cause the at least one processor to perform one or more tasks, comprising:
processing visual data from one or more image capture devices and audio data from microphones;
identifying and tracking intruders and intruding vehicles within a facility;
accepting feedback from observers, wherein the observers:
monitor the identification and tracking performed by the generative AI system;
monitor system response provided by the generative AI system based on the identification and tracking performed by the generative AI system;
processing the feedback provided by the observers to reduce false positives and other errors associated with the generative AI system;
interpreting level of threat in an intruder's behavior in real time;
creating a virtual guard persona, comprising;
generating a simulated human voice; and
generating a simulated human avatar;
employing a Turing test to fine tune intelligent behavior of the created virtual guard persona, until it is not possible to distinguish between the created virtual guard persona and a real human guard;
engaging in real-time verbal exchanges with the intruder, using the created virtual guard persona, to deter the intruder from committing a crime;
escalating the verbal exchanges in tone and language based on the intruder's actions and responses;
delivering the simulated human voice to the intruder via the speakers; and
deterring the intruder with additional and optional lights and sirens.

12. The method of claim 11, wherein the generative AI system is further configured to:
analyze the intruder's facial expressions, body language, and other behavioral cues;
tailor the verbal exchanges to the intruder's individual characteristics;
learn from past interactions with the intruders;
tailor system response specific to a particular image capture device and field of view, including reference to objects, scenery and the field of view;
adapt the verbal exchanges based on the tailored system response;
improve effectiveness of the verbal exchanges over time; and
tailor the system response based on the intruder's appearance and behavior as seen across different image capture devices.

13. The method of claim 11, wherein the generative AI system is further configured to:
integrate with other security systems, such as access control system and alarm system;
coordinate actions with other security personnel;
provide real-time updates on the intruder's situation;
project the simulated human avatar onto a screen or display within the facility;
create an appearance or illusion that the simulated human avatar is physically present within the facility; and
create a situation where the simulated human avatar appears to be watching the intruder through the image capture devices.

14. The method of claim 11, wherein the generative AI system is further configured to:
adjust volume and pitch of the simulated human voice to create a sense of intimidation or urgency;
use ambient sounds from the facility to enhance realism of the verbal exchanges;
mimic sound of footsteps or other movements to create a sense of presence;
identify and exploit the intruder's vulnerabilities or fears;
use psychological techniques to manipulate the intruder's behavior; and
project future states, such as non-compliance leading to monetary fines, incarceration and loss of freedom, and compliance leading to avoiding the non-compliance.

15. The method of claim 11, wherein the generative AI system is further configured to:
create a sense of isolation and helplessness in the intruder;
learn from interactions with the intruders across multiple facilities;
adapt different strategies for different types of intruders and situations; and
improve ability to achieve compliance with defined security policy and deter crime over time.

16. The method of claim 11, wherein the false positives and errors associated with the generative AI system comprise inappropriate text, voice, or image generation or decision by the generative AI system, wherein the false positives and errors associated with the generative AI system further comprise illusion of presence of the virtual guard persona, which may be counter to objective of deterrence or safety, and wherein use of a combination of the generative AI system and the observers achieves dual objective of: (a) reducing errors specific to the observers as well as the errors specific to the generative AI system, and (b) reducing overall cost associated with the surveillance system that utilizes only the observers or only the generative AI system.

17. The method of claim 11, wherein:
the image capture devices are capable of automatically adjusting their brightness and contrast and switching to infrared imaging based on ambient lighting conditions of field of view at any given time;
the image capture devices transmit variable frame rates through one or more of a cable, WI-FI, and Bluetooth connection;
the image capture devices possess a built-in motion detection capability to transmit image frames or video only when motion or scene lighting change is detected; and
the image capture devices possess a built-in audio detection capability to transmit frames or video only when there are sounds that indicate presence of the intruders or the intruding vehicles.

18. The method of claim 11, wherein the generative surveillance system further comprises a situational awareness artificial intelligence system for interpreting inputs from the one or more image capture devices and a configured schedule of expected activities as well as regions of interest in field of view of each image capture devices, and providing the interpreted inputs to the generative AI system, wherein the generative AI system generates human-like responses based on the interpreted inputs provided by the situational awareness artificial intelligence system.

19. The method of claim 11, configured to work with a two-factor authentication system, wherein the two-factor authentication system comprises:
a coded lock superimposed/configured to be superimposed on a traditional lock, wherein the two-factor authentication system comprises a code of the coded lock and a key of the traditional lock.

20. The method of claim 11, configured to work with a two-factor authentication system, wherein the two-factor authentication system comprises:
a key fob/card; and
an image capture based recognition system configured to recognize one or more of a face or a vehicular license plate.
